(19) United States
(12) Patent Application Publication
(10) Pub. No.: US 2018/0217578 A1
(43) Pub. Date: Aug. 2, 2018

(54) DEVICE FOR ADDITIVE MANUFACTURE OF THREE-DIMENSIONAL OBJECTS

(71) Applicant: CL SCHUTZRECHISVERWAL TUNGS GMBH, Lichtenfels (DE)

(72) Inventor: Fabian ZEULNER, Lichtenfels (DE)

(73) Assignee: CL SCHUTZRECHISVERWAL TUNGS GMBH, Lichtenfels (DE)

(21) Appl. No.: 15/881,643

(22) Filed: Jan. 26, 2018

(30) Foreign Application Priority Data
Jan. 27, 2017 (DE) 102017101636.8

(51) Int. Cl. G05B 19/4099; G06F 21/31

(52) U.S. Cl. CPC G05B 19/4099; G05B 2219/49023; G06F 21/31

(57) ABSTRACT

A device (1) for additive manufacture of three-dimensional objects (2) by successive, layered, selective illumination and therewith associated successive, layered, selective solidification of built material layers from a construction material (3) solidified by an energy beam (4) comprising an authorization device (11) for authorization of at least one user (12) of the device (1) for use of at least one operating status of the device (1), whereby the authorization device (11) comprises at least one recording device (14), which is set up for recording of at least one acoustic feature, optical feature, or bodily feature of a potential user (12) of the device (1).

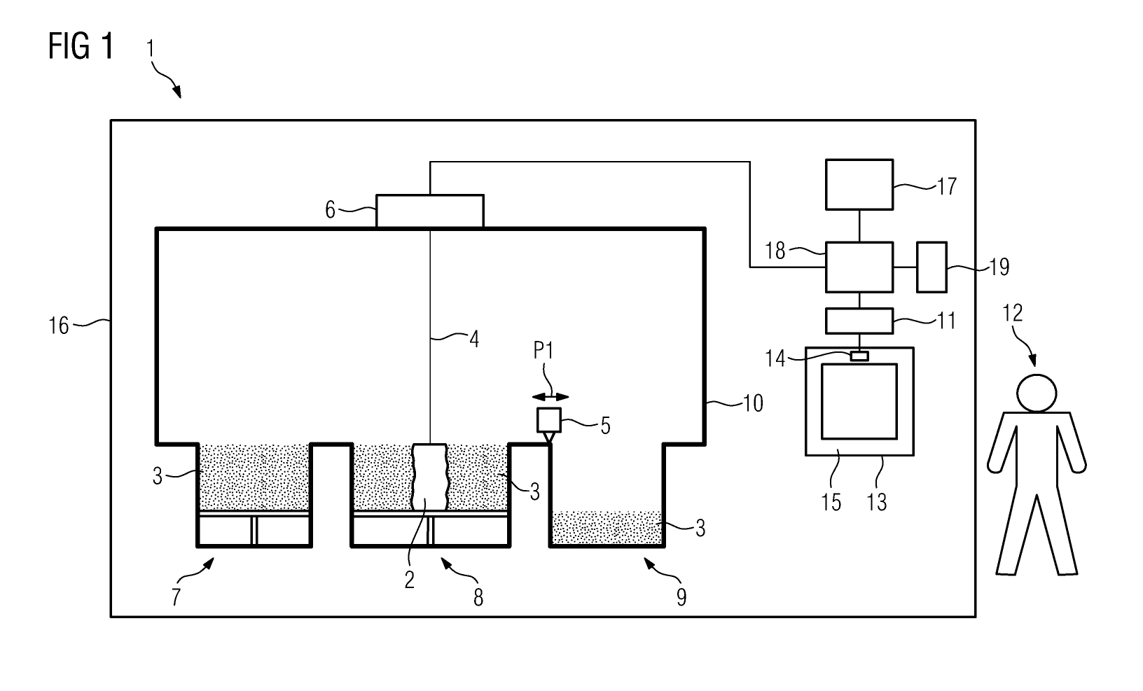

The invention concerns a device for additive manufacture of three-dimensional objects through successive, layered, selective illumination and thereby associated successive, layered, selective solidification of layers of construction material from a solidifiable construction material by means of an energy beam, comprising an authorization device, which is configured for authorization of at least one user of the device for use of at least one operational status of the device.

By means of corresponding devices, additive manufacture of three-dimensional objects by means of successive, layered, selective illumination and thus associated successive, layered, selective solidification of built material layers is accomplished in the corresponding areas of the layered cross section of the object to be produced from a solidifiable powder construction material by means of energy beams.

It is further known that corresponding devices comprise an authorization device, which is configured for authorization of at least one user of the device for use of at least one operational status of the device. The authorization of a user of the device is currently done via entry by the user of a given password at a user interface on the device.

This represents a condition that can be improved, especially due to the fact that construction material particles can deposit on the user interface so that the user can come into contact with construction material when entering a password for authorization. For reasons of security every contact by a user with construction material must by avoided to the extent possible.

The underlying object of the invention is to demonstrate an improved device for additive manufacture of three-dimensional objects especially in view of authorization of a user, whereby the user to the greatest extent possible does not come into contact with the construction material.

The role is fulfilled by a device for additive manufacture of three-dimensional objects in accordance with claim 1. The appurtenant dependent claims concern possible forms of embodiment of the method.

The device (“device”) described herein is configured for additive manufacture of three-dimensional objects, i.e. for example technical components or technical component groups, by means of successive, layered, selective illumination and thus associated successive, layered, selective solidification of built material layers from a solidifiable construction material in corresponding areas of the layered cross section of the object to be produced. The construction material can be a metallic, plastic, and/or ceramic material in particulate or powder form. The selective solidification of built material layers that will be selectively solidified is accomplished on the basis of construction data of the object. Corresponding construction data describe the geometrically constructive form of the object to be additively manufactured and can, for example, contain “sliced” CAD data of the object that is additively constructed. The device can, for example, be an SLM device, i.e. a device for carrying out selective laser melt methods (SLM methods) or configured as an SLS device, i.e. as a device for carrying out selective laser sinter methods (SLS methods). It is also possible that the device can be configured as an SEBS device, i.e. a device for carrying out selective electron beam melt procedure (SEBS procedure).

The device comprises the functional components necessary for carrying out additive construction steps. A layering device and an illumination device are included in particular. The coating device is configured for formation of selectively illuminated or selectively solidified built material layers in a construction level or construction field of the device, in which the successive layered selective illumination and the associated successive, layered successive solidification of built material layers from the construction material solidified by an energy beam are carried out. The illumination device is configured for selective illumination of built material layers to be solidified in the construction level of the device.

The device comprises an authorization device. The authorization device implemented by hardware or software is configured for authorization of at least one user of the device for use of at least one operational status of the device. The authorization device is in general carried out by means of authorization procedures. An authorization procedure enables authorization of a user, so that he or she can use at least one operating level after successful authorization. Corresponding authorization procedures increase operational security of the device, since only authorized users of the device have a possibility of using the operational level of the device.

An operational level of the device can mean entry into service of the device, i.e. switching on the device or a functional component of the device, exiting from the device, i.e. switching off the device or a functional component of the device, or it could have to do with a given operating mode of the device put into service. An operational mode of the device can have to do with a demonstration or simulation mode in which carrying out additive construction procedures is only demonstrated or simulated, but the additive construction procedures are not in fact carried out. It can be a construction mode in which additive construction procedures are in fact carried out or concern, for example, a programming mode in which at least one construction parameter such as the intensity of the energy beam is programmable in connection with carrying out construction procedures.

The authorization device comprises at least one recording device. The recording device implemented by hardware or software is configured for recording at least an acoustic feature, optical feature, or the physical characteristics of a potential user. In contrast with the initially described state of the art, authorization is done via automatable or automatic recording of acoustic features and/or optical features and/or further physiological characteristics of a potential user of the device, as indicated in the following. Authorization procedures are carried out very efficiently on the basis of recorded acoustic features and/or optical features and/or further physiological characteristics of a potential user of the device. Active participation by a user, i.e. particularly entry of a certain password on a user interface of a device, is typically not necessary. During authorization a potential user of the device typically has no—or altogether in connection with recording of physical features—a comparatively only minimal (physical) contact with the device. The potential user of the device does not come into contact with construction material during the authorization process. In this regard, the technology of the device is improved in comparison with the state of the art described initially.

The recording device can be configured or embodied as an optical recording device, i.e. especially as an imaging device, preferably as a camera. An optical recording device is implemented for recording at least an optical feature of the physical characteristics of a potential user of the device. Optical features of a potential user of the device are, in particular, optically ascertainable features, for example an optically ascertainable configuration of given optically ascertainable features of the potential user of the device. It can concretely be corresponding features, for example facial features of the user. The recording device, or the authorization device, is typically equipped with appropriate algorithms for data recording and evaluation of corresponding optical features.

The recording device, or an alternative supplementary recording device, can be configured as an acoustical recording device, especially as a sound recording device, preferably as a microphone device, or include one. An acoustical recording device is configured for recording at least one acoustical feature of a potential user of the device. Acoustical features of a potential user of the device are, in particular, acoustically ascertainable features of the potential user of the device. It can concretely be corresponding features, for example features of the (spoken) language, i.e. particularly the amplitude, or frequency, of the user. The recording device, or the authorization device, is typically equipped with appropriate algorithms for data recording and evaluation of corresponding acoustic features.

Finally, the recording device, or an alternative recording device, can be designed or comprise a biometric recording device, particularly as a finger print scanner. The biometrical recording device is configured for recording at least one physical feature of a potential user of the device. Physical features of a user of the device are, in particular, biometrically ascertainable features of the potential user of the device. Concretely, it is a matter of corresponding features of the user, for example the finger, specifically the finger print. The recording device, or the authorization device, is typically equipped with appropriate algorithms for data recording and evaluation of corresponding physical features.

It is the case for all embodiments of the recording device that the recording device is appropriately configured to carry out a recording of at least an acoustical feature, optical feature, or physical feature of a potential user of the device by automatically recording a potential user approaching the device. This enables automatable or automatic recording of features of users and thus automatable or automatic authorization procedures of a user. For recording a potential user approaching the device or having reached the device, the recording device can comprise appropriate recording elements, i.e. proximity sensors. The recording device can, of course, comprise a separate recording device with corresponding recording elements for recording a potential user approaching the device or having reached the device.

It further holds for all exemplary embodiments that the recording device can be on or in a housing on the side of the device, especially in the area of, especially above, a viewing window giving a view into the process chamber of the device. The recording device can thus be integrated or configured on or into a housing on the side of the device, particularly on a frame element of the housing. Alternatively or additionally, the present or a further recording device can be integrated or configured on or in a user interface on the side of the device, in particular a touch display device. The present or a further recording device can thus alternatively or additionally be integrated or configured on or into a user interface, i.e. a touch display device, especially on a frame element of the touch display device.

The device advantageously comprises a storage device coordinating or coordinated with the authorization device to be characterized or considered to be a data storage device. User data of authorized users can in the sense of a user data bank be stored in the hardware and software storage device. The user data can contain or describe certain acoustic features, optical features, or physical features of users authorized for use of at least one operational state of the device. Corresponding user data can, of course, especially in connection with authorization or with possible use of operational states after successful authorization, contain or describe, for example, the person's name, position in the operation, association with the operation, etc. The user data stored in the storage device enable matching stored features of a potential user of the device with data from features stored for authorized users in the context of an authorization procedure.

User profile data of authorized users of the device can be stored in the present or a further storage device associated or associable with the authorization device. The user profile data can contain or describe the authorized operational conditions of the device for use of at least one operational status of the device. The user profile data contain or, in other words, describe the assigned usage authorization for authorized users of the operational conditions of the device. After successful authorization of a user, the user profile data stored in the storage device enable an automatable or automatic selection and use of the user profile data by the given authorized user.

The device advantageously comprises a control device coordinated or able to be coordinated with the authorization device and the storage device(s). The control device implemented by hardware and/or software is configured to compare recorded information from a recording device describing at least one respective recorded acoustic feature, optical feature, or physical feature of a potential user of the device and to produce a corresponding result through comparison with descriptive information on the result of the comparison.

The control device is configured from the comparison data rendering of a positive comparative result as a basis for an authorized user to use allocated profile data for control of the operation of the device.

With comparative result information describing a negative result of comparison, i.e. in the case of repeated unsuccessful authorization of a potential user of the device, the control device can be configured to transmit the comparative result information to a monitoring device to monitor the operation of the device and in a given case the operation of further components of a facility for additive manufacture of three-dimensional objects. To this end, the device comprises a data transmission device that can be or is connected with the control device, which allows for transmission of data, in a given case encrypted data, by cable or wirelessly, i.e. in particular also corresponding comparative result information to a transmission partner, i.e., in particular, a corresponding monitoring device. A positive comparative result describing comparison result data can, of course, also be transmitted to a transmission partner, i.e. particularly a corresponding monitoring device.

In addition to the device, the invention concerns a procedure for operation of a device for additive manufacture of three-dimensional objects by means of successive, layered, selective illumination and thus associated successive, layered, selective solidification of built material layers from a solidifiable powder construction material by means of an energy beam. The procedure is characterized in that the operation of the device is on the basis of an authorization device, which is configured for authorization of at least one user of the device for use at least of one operational state of the device, whereby the authorization device comprises at least one recording device, which is configured for recording at least one acoustic feature, optical feature, or physical feature of a potential user of the device. The method can be implemented with a device as described. All embodiments in connection with the device apply analogously to the method.

The invention is explained in more detail in the exemplary embodiments in the drawings. The only Fig. shows a schematic diagram of a device according to an exemplary embodiment.

The Fig. shows a schematic diagram of a device 1 according to an exemplary embodiment.

Device 1 enables the additive manufacture of three-dimensional objects 2, i.e., in particular, technical components or technical component groups by means of successive, layered, selective illumination and thus associated successive, layered, selective solidification of built material layers from a solidifiable powder construction material 3 by means of an energy beam 4, i.e. specifically a laser beam. The selective solidification of built material layers to be solidified is accomplished on the basis of construction data of the object. Corresponding construction data describe the geometrical or geometrically constructive form of the object 2 to be additively manufactured and can, for example, contain “sliced” CAD data of the object 2. Device 1 can, for example, be configured as a Laser-CUSING® device, i.e. as a device for carrying out selective laser melting procedures (SLM procedures).

Device 1 comprises the necessary functional components for carrying out additive construction steps. In the Fig. a coating device 5 and an illumination device are shown. Coating device 5 is for formation of selectively illuminated or selectively solidified built material layers to be selectively solidified in a construction level or a construction field of device 1 and comprises a movably mounted, specifically a blade-like or blade-shaped, coating element (not described in more detail), relative to a construction level or construction field of device 1, as indicated by means of double arrow P1. Illumination device 6 is for selective illumination of selectively solidified built material layers in the construction level of device 1 and for this purpose comprises a beam generator (not shown), which is configured for generating an energy beam 4, in a given case a beam deflection device (not shown) that is configured for deflection of an energy beam 4 to an area to be illuminated selectively onto a built material layer to be solidified, and diverse optical elements such as filter elements, objective elements, lens elements, etc.

In the Fig. a dosing module 7, a construction module 8, and an overflow module 9 are also shown, which are docked on a lower area of a processing chamber 10 of device 1 into which inert gas can be released. The mentioned modules can also form a lower area of process chamber 14 of device 1.

Device 1 comprises an authorization device 11 implemented by hardware or software, which is configured for authorization of at least one user 12 of device 1 for use of at least one operational status of device 1. Authorization device 11 is configured to carry out authorization procedures, which enable authorization of a user 12 so that he or she after successful authorization can use at least one operating level of device 1.

An operational level of device 1 can mean entry into service of device 1, i.e. switching on device 1 or a functional component of device 1, i.e. of the exposure to light device 6, removal from service of device 1, i.e. shutting down device 1, or a functional component of device 1, i.e. of illumination device 6 or a certain operating mode device 1 put into service. An operational mode of device 1 may have to do with a demonstration or simulation mode in which carrying out additive construction procedures are only demonstrated or simulated, but the additive construction procedures are not in fact carried out. It can be a construction mode in which additive construction procedures are in fact carried out or concern, for example, a programming mode in which at least one operational parameter, i.e. an illumination parameter, such as the intensity of the energy beam is programmable in connection with carrying out construction procedures.

Authorization device 11 comprises recording device 14 implemented by hardware and/or software, which is configured for recording of at least an acoustic feature, optical feature, or the physical characteristics of a potential user 12 of device 1. Authorization of a user 12 is done via automatable or automatic recording of acoustic features and/or optical features and/or further physiological characteristics of a potential user 12 of the device 1. Active action by a user, i.e. particularly entry of a certain password on a user interface 13 on a device, is not necessary. A potential user 12 of the device 1 typically has no or altogether in connection with recording of physical features, a comparatively only minimal (physical) contact with the device 1. The potential user 12 of the device 1 does not or scarcely comes into contact with construction material 3 during the authorization process.

Recording device 14 is configured in the embodiment shown in the Fig. as an optical recording device, i.e. as an image capture device, particularly as a camera, and configured for recording of at least an optical feature of a potential user 12 of device 1. Optical features of a potential user 12 of the device 1 are in particular optically ascertainable features, for example an optically ascertainable configuration of given optically ascertainable features of the potential user 12 of the device 1. It can concretely be corresponding features, for example facial features of the user 12. The recording device 14, or the authorization device 11, is typically equipped with appropriate algorithms for data recording and evaluation of corresponding optical features.

The recording device 14 shown in the example in the Fig. is designed or configured in the user interface 13, at which there is, for example, a touch display device, i.e. in particular in a frame element of user interface 13. An alternative would be, for example, an arrangement or design on or in an (external) housing 16 on the side of the device, especially in the area above a viewing window (not shown) giving a view into the process chamber 10 of the device 1. The recording device 14 could also be configured on or integrated into a housing 16 on the side of the device, particularly on a frame element (not described more closely) of the housing.

The recording device 14 is configured to carry out a recording of at least an acoustical feature, optical feature, or physical feature of a potential user 12 of the device 1 by automatically recording a potential user 12 approaching the device 1. For recording a potential user 12 approaching the device 1 or having reached the device 1, the recording device can comprise appropriate recording elements (not shown), i.e. proximity sensors. The recording device 1 can, of course, comprise a separate recording device (not shown) with corresponding recording elements for recording a potential user 12 approaching the device or having reached the device.

In the Fig. is further shown a storage device 17 coordinating or coordinated with the authorization device 11 to be characterized or considered also to be a data storage device. User data of authorized users 12 implemented in the hardware and/or software are stored in storage device 17. The user data can contain or describe certain acoustic features, optical features, or physical features of authorized users 12 authorized for use of at least one operational state of the device 1. Corresponding user data could, of course, especially in connection with authorization or with possible use of operational states of device 1 after successful authorization, contain or describe, for example, relevant data of the user 12, i.e. the person's name, position in the operation, association with the operation, etc. The user data stored in the storage device 17 enable matching stored features of a potential user 12 of the device 1 with data from features stored for authorized users in the context of an authorization procedure.

User profile data of authorized users 12 of the device 1 can be stored in the storage device 17. The user profile data contain or describe the authorized operational conditions of the device 1 for use of at least one operational status of the device 1 by authorized users 12. After successful authorization of a user 12, the user profile data stored in the storage device 17 enable an automatable or automatic selection and use of the user profile data by the given authorized user 12.

In the Fig. is further shown a control device 18 coordinating or coordinated with the authorization device 11 and the storage device 17. The control device 18 implemented by hardware and/or software is configured to compare recorded data which, as a function of features generated at recording device 14 (on the one hand), depict a given recorded acoustic feature, an optical feature or body feature of a potential user 12 of device 1, with user data saved in storage device 17, and to generate comparison data depicting a corresponding comparative result.

The control device 18 can be configured in the case of a positive descriptive comparative result from comparative result in formation, i.e. be configured in the case of successful authorization of a user 12 to be used as dedicated user profile data to control the operation of device 1. With comparative result information of a negative comparative result, i.e. in the case of possibly repeated unsuccessful authorization of a potential user 12 of the device 1, the control device 18 can be configured to transmit the comparative result information to a supervising monitoring device (not shown) as part of a facility (not shown) for additive manufacture of three-dimensional objects 2. The device 1 comprises (optionally) a data transmission device 19 assigned to control device 18 that can be or is connected with the control device, which allows for transmission of data, in a given case encrypted data, by cable or wirelessly, i.e. in particular also corresponding comparative result information to a transmission partner, i.e., in particular, a corresponding monitoring device. A positive comparative result describing comparison result data can, of course, also be transmitted to a transmission partner, i.e. particularly a corresponding monitoring device.

Even though an optical recording device is shown in the example in the Fig., the alternative or an alternative, i.e. supplementary recording device 14, can be configured as an acoustic recording device, specifically as a sound recording device, preferably as a microphone device. An acoustical recording device is configured for recording at least one acoustical feature of a potential user 12 of the device 1. Acoustical features of a potential user 12 of the device 1 are in particular acoustically ascertainable features of the potential user 12 of the device 1. It can concretely be corresponding features, for example features of the (spoken) language, i.e. particularly amplitude and frequency, of the user 12. The recording device, or the authorization device, is typically equipped with appropriate algorithms for data recording and evaluation of corresponding acoustic features.

The recording device 14, or an alternative or supplementary recording device, can comprise a biometric recording device, particularly as a finger print scanner. The biometrical recording device is configured for recording at least one physical feature of a potential user 12 of the device 1. Physical features of a user 12 of the device 1 are in particular biometrically recordable features of the potential user 12 of the device 1. Concretely, it can be a matter of corresponding features of the user, for example the finger, specifically the finger print of user 12. The recording device, or the authorization device, is typically equipped with appropriate algorithms for data recording and evaluation of corresponding physical features.

A procedure for operation of a device 1 shown in the example for additive manufacture of three-dimensional objects 2 by means of successive, layered, selective illumination and thus associated successive, layered, selective solidification of built material layers from a solidifiable powder construction material 3 by means of an energy beam 4. The procedure is characterized in that the operation of the device 1 is configured on the basis of an operational status by means of an authorization device 11, which for authorization of at least one user 12 of the device 1 for use at least of one operational state of the device 1, whereby the authorization device 11 comprises at least one recording device 14, which is configured for recording at least one acoustic feature, optical feature, or physical feature of a potential user 12 of the device 1.

1. A device (1) for additive manufacture of three-dimensional objects (2) by successive, layered, selective illumination and therewith associated successive, layered, selective solidification of built material layers from a construction material (3) solidified by an energy beam (4) comprising an authorization device (11) for authorization of at least one user (12) of the device (1) for application of at least one operating status of the device (1) characterized in that the authorization device (11) comprises at least one recording device (14), which is set up for recording at least one acoustic feature, optical feature, or physical characteristic of a potential user (12) of the device (1).

2. A device according to claim 1 characterized by a storage device (17), in which user data are stored, which describe certain acoustic features, optical features, or physical characteristics of users (12) authorized for use of at least one operating state of the device (1).

3. A device according to claim 1 characterized by a storage device (17), in which user profiles are stored for use of at least one of the operating modes of the device (1) describe the users (12) authorized for use of at least one operating mode of the device (1).

4. A device according to claim 2 characterized by a control device (18) that is configured to compare recorded data which as a function of features generated by the recording device (14) depicts a given recorded acoustic feature, an optical feature or physical feature of a potential user (12) of the device (1), with user data saved in the storage device (17), and to generate comparison data depicting a corresponding comparative result.

5. A device according to claim 4 characterized in that the control device (18) is configured from the comparison data rendering of a positive comparative result as a basis for an authorized user to use allocated profile data for control of the operation of the device.

6. A device according to claim 4 characterized in that the control device (18) is configured from the comparison data rendering of a negative comparative result to be used to transmit the comparative result information to a monitoring device monitoring the operation of the device (1) and, in a given case, the operation of further devices.

7. A device according to one claim 1 characterized in that the recording device (14) is configured as an optical recording device, specifically as an image capture device or comprises one, which is for recording of at least one optical characteristic of a potential user (12) of the device (1) or as an acoustic recording device or the recording device (14) is configured as an acoustic recording device especially as a sound recording device or comprises one, which for recording at least the acoustic features of a potential user (12) of the device (1), or of the recording device (14) as a biometric recording device, especially as a finger print scanner or it includes one, which is configured for recording at least one physical characteristic of a user (12) of the device (1).

8. A device according to claim 1 characterized in that the recording device (14) is configured to carry out recording of at least an acoustic characteristic, optical characteristic, or physical characteristic of a potential user (12) of the device (1), automatically in recording a potential user (12) approaching the device (1) or a potential user (12) who has approached the device (1).

9. A device according to claim 1 characterized in that the or a recording device (14) at or in a housing (16) on the side of the device, located or configured especially in the area, especially above, a viewing window giving a view into the process chamber (10) of the device (1) or the recording device (14) on or in a user interface (13), in particular a touch display device that is installed or configured on a housing (16) on the side of the device.

10. A device according to claim 1 characterized in that an operating condition of the device (1), is entry into service of the device (1), taking out of service of the device (1), or taking a given operating mode of the device (1) into service, in particular a demonstration or simulation mode, a construction mode, or a programming mode.

11. A process for operation of a device (1) for additive manufacture of three-dimensional objects (3) by successive, layered, selective illumination and therewith associated successive, layered, selective solidification of built material layers from a construction material (3) solidified by an energy beam (4) in particular a device (1) according to claim 1 characterized in that the operation of device (1) on the basis of authorization of a potential user (12) of the device (1) is governed by means of an authorization protocol (11), which authorizes at least one user of the device (1) for use of at least one operational status of the device (1), whereby the authorization protocol (11) comprises at least one recording device (14), which for recording of at least one acoustic feature, optical feature, or physical feature of a potential user (12) of the device (1) grants authorization to one potential user (12).
